(19) United States
(12) Patent Application Publication
(10) Pub. No.: US 2026/0338610 A1
(43) Pub. Date: Oct. 29, 2026

(54) DEVICES, SYSTEMS, AND METHODS FOR TEMPERATURE SENSING

(71) Applicant: STMicroelectronics International N.V., Geneva (CH)

(72) Inventors: Jiri RYBA, Czechia (CZ); Xiaoxian LI, Shanghai (CN); Matteo ABATE, Napoli (IT); Vittorio D'ANGELO, Nocera Superiore (IT); Salvatore CANNAVACCIUOLO, Napoli (IT)

(21) Appl. No.: 19/572,091

(22) Filed: Mar. 19, 2026

Related U.S. Application Data
(63) Continuation-in-part of application No. 19/190,092, filed on Apr. 25, 2025.

(51) Int. Cl. G01K 1/02; G01K 7/16; H01M 10/42; H01M 10/48

(52) U.S. Cl. CPC G01K 1/026; G01K 7/16; H01M 10/425; H01M 2010/4271; H01M 10/486

(57) ABSTRACT

A temperature sensing method comprising arranging a plurality of resistive temperature sensors (RTSs) in groups, each group comprising a same number of RTSs, each RTS having first and second ends, positioning each RTS adjacent a structure whose temperature is to be determined, connecting the first end of each RTS in a same group to a respective first node, connecting fixed-resistance resistors between a supply voltage and each first node, connecting the second end of each RTS to one respective RTS in each other group via second nodes, connecting each first node to a respective first input of a device and each second node to a respective second input, wherein quantities of resistors and first nodes equal the quantity of groups, and second nodes equal the quantity of RTSs per group.

This application is a continuation-in-part of and claims priority to U.S. patent application Ser. No. 19/190,092, filed on Apr. 25, 2025 and titled “DEVICES, SYSTEMS, AND METHODS FOR TEMPERATURE SENSING,” which is incorporated herein by reference in their entirety.

### FIELD OF INVENTION

Example embodiments of the present disclosure relate generally to temperature sensing and, more particularly, to temperature sensing using a plurality of resistive temperature sensors.

### BACKGROUND

A battery energy storage system is a type of energy storage technology that uses a group of batteries to store electrical energy. Battery energy storage systems can provide a quickly dispatchable source of power on electric grids and are used to stabilize those grids, as battery energy storage systems can transition from standby to full power in under a second to deal with grid contingencies.

Battery energy storage systems typically comprise a number of battery packs, and each battery pack typically comprises a number of battery cells. Battery monitoring systems (BMSs) are used to monitor several variables of the battery cells, such as voltage, current, and temperature. Temperature monitoring can help prevent fires by shutting down the battery cell if the temperature rises above a predetermined threshold.

Temperature sensors adjacent to the battery cells are used to monitor temperatures. Resistive type temperature sensors (RTSs), such as negative-temperature-coefficient (NTC) or positive-temperature-coefficient (PTC) sensors are typically used. Such NTC and PTC sensors are also called NTC and PTC thermistors. With NTC sensors, resistance decreases as temperature rises, while, with PTC sensors, resistance increases as temperature rises. The change in resistance can be measured (directly or indirectly) to determine the temperature of the battery cell.

In one example approach that has been used before, one temperature sensor is used to monitor two battery cells. The temperature sensors are typically connected to a BMS analog front end (AFE), which typically includes multiple analog-to-digital converter (ADC) inputs to convert the analog signal from the temperature sensor to digital such that the BMS AFE can provide those digital values to a BMS microcontroller (MCU).

Safety standards in some countries require one temperature sensor for each battery cell, rather than a shared configuration. The challenge with having one temperature sensor for each battery cell is that the BMS AFE often does not have enough ADC inputs to interface with such a large number of temperature sensors. To address this problem, it is known to use analog multiplexers to increase the number of temperature sensors that can be interfaced to a BMS AFE with insufficient ADC inputs. In some approaches, multiple chained analog multiplexers may be used if needed. While the use of such analog multiplexers works, this configuration adds cost and complexity.

Applicant has identified many technical challenges and difficulties associated with temperature sensing using a plurality of resistive temperature sensors. Through applied effort, ingenuity, and innovation, Applicant has solved problems related to temperature sensing using a plurality of resistive temperature sensors by developing solutions embodied in the present disclosure, which are described in detail below.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

Various embodiments described herein related to devices, systems, and methods for temperature sensing using a plurality of resistive temperature sensors.

According to an aspect of the present disclosure, a temperature sensing method is provided. The method comprises arranging a plurality of resistive temperature sensors (RTSs) in a plurality of groups, each group comprising a same number of RTSs, each RTS having a first end and a second end. The method comprises positioning each RTS adjacent a structure whose temperature is to be determined. The method comprises, for each group of RTSs, connecting the first end of each RTS in a same group to a respective one of a plurality of first nodes. The method comprises connecting a first end of each of a plurality of resistors each having a fixed, known resistance value to a supply voltage and a second end of each of the plurality of resistors to the first node of a respective group of RTSs. The method comprises connecting the second end of each RTS to the second end of one respective RTS in each other group of RTSs via a respective one of a plurality of second nodes. The method comprises connecting each of the first nodes to a respective first input of a device having a plurality of first inputs and a plurality of second inputs. The method comprises connecting each of the second nodes to a respective second input of the device. A quantity of the resistors equals a quantity of the groups of the RTSs. A quantity of the first nodes equals a quantity of the groups of the RTSs. A quantity of the second nodes equal a quantity of the RTSs in each group of the RTSs.

According to other aspects of the present disclosure, the method may include one or more of the following features. The method may further comprise (a) setting a first one of the second inputs to ground and others of the second inputs to a high resistance mode such that current flows through each RTS connected to a corresponding one of the second nodes connected to the first one of the second inputs. The method may further comprise (b) measuring a voltage at a first one of the first inputs. The method may further comprise (c) measuring a voltage at each of the second inputs. The method may further comprise (d) determining a current through a corresponding one of the plurality of resistors by subtracting the measured voltage at the first one of the first inputs from the supply voltage and dividing by the known resistance value of the corresponding one of the plurality of resistors. The method may further comprise (e) repeating (a) through (d) for each subsequent ones of the second inputs. The method may further comprise (f) determining a resistance value for each RTS whose first end is connected to the respective first node connected to the first one of the first inputs by solving a matrix equation comprising (i) the measured voltages at each of the second inputs for each different one of the second inputs being set to ground, (ii) an unknown conductance value of each RTS whose first end is connected to the respective first node connected to the first one of the first inputs, and (iii) the determined current through the corresponding one of the plurality of resistors. The method may further comprise repeating (a) through (f) for each subsequent one of the first inputs and groups of RTSs. Each of the first inputs of the device may comprise an analog-to-digital controller (ADC) and each of the second inputs of the device may comprise a general purpose input. Each of the RTSs may comprise either a negative-temperature-coefficient sensor or a positive-temperature-coefficient sensor. The device may comprise an analog front end. The device may comprise a microcontroller.

According to another aspect of the present disclosure, a temperature sensing device is provided. The device comprises a plurality of first inputs and a plurality of second inputs. The device comprises control circuitry. The control circuitry is adapted to determine a resistance of each of a plurality of resistive temperature sensors (RTSs) arranged in a plurality of groups, each group comprising a same number of RTSs, each RTS having a first end and a second end. For each group of RTSs, the first end of each RTS in a same group is connected to a respective one of a plurality of first nodes. A first end of each of a plurality of resistors each having a known resistance value is connected to a supply voltage and a second end of each of the plurality of resistors to the first node of a respective group of RTSs. The second end of each RTS is connected to the second end of one respective RTS in each other group of RTSs via a respective one of a plurality of second nodes. Each of the first nodes is connected to a respective first input of a device having a plurality of first inputs and a plurality of second inputs. Each of the second nodes is connected to a respective second input of the device. A quantity of the resistors equals a quantity of the groups of the RTSs. A quantity of the first nodes equals a quantity of the groups of the RTSs. A quantity of the second nodes equal a quantity of the RTSs in each group of the RTSs.

According to other aspects of the present disclosure, the device may include one or more of the following features. The control circuitry may be configured to (a) set a first one of the second inputs to ground and others of the second inputs to a high resistance mode such that current flows through each RTS connected to a corresponding one of the second nodes connected to the first one of the second inputs. The control circuitry may be configured to (b) measure a voltage at a first one of the first inputs. The control circuitry may be configured to (c) measure a voltage at each of the second inputs. The control circuitry may be configured to (d) determine a current through a corresponding one of the plurality of resistors by subtracting the measured voltage at the first one of the first inputs from the supply voltage and dividing by the known resistance value of the corresponding one of the plurality of resistors. The control circuitry may be configured to (e) repeat (a) through (d) for each subsequent ones of the second inputs. The control circuitry may be configured to (f) determine a resistance value for each RTS whose first end is connected to the respective first node connected to the first one of the first inputs by solving a matrix equation comprising (i) the measured voltages at each of the second inputs for each different one of the second inputs being set to ground, (ii) an unknown conductance value of each RTS whose first end is connected to the respective first node connected to the first one of the first inputs, and (iii) the determined current through the corresponding one of the plurality of resistors. The control circuitry may be further configured to repeat (a) through (f) for each subsequent one of the first inputs and groups of RTSs. Each of the first inputs of the device may comprise an analog-to-digital controller (ADC) and each of the second inputs of the device may comprise a general purpose input. Each of the RTSs may comprise either a negative-temperature-coefficient sensor or a positive-temperature-coefficient sensor. The device may comprise an analog front end. The device may comprise a microcontroller.

According to another aspect of the present disclosure, a temperature sensing system is provided. The system comprises a plurality of resistive temperature sensors (RTSs) arranged in a plurality of groups, each group comprising a same number of RTSs, each RTS adapted to be positioned adjacent a structure whose temperature is to be determined, wherein, for each group of RTSs, a first end of each RTS in a same group is connected to a respective one of a plurality of first nodes. The system comprises a plurality of resistors each having a fixed, known resistance value, a first end of each of the plurality of resistors is adapted to be connected to a supply voltage and a second end of each of the plurality of resistors is connected to the first node of a respective group of RTSs. The system comprises a device having a plurality of first inputs and a plurality of second inputs. For each group of RTSs, the first end of each RTS in a same group is connected to a respective one of a plurality of first nodes. A first end of each of a plurality of resistors each having a known resistance value is connected to a supply voltage and a second end of each of the plurality of resistors to the first node of a respective group of RTSs. The second end of each RTS is connected to the second end of one respective RTS in each other group of RTSs via a respective one of a plurality of second nodes. Each of the first nodes is connected to a respective first input of a device having a plurality of first inputs and a plurality of second inputs. Each of the second nodes is connected to a respective second input of the device. A quantity of the resistors equals a quantity of the groups of the RTSs. A quantity of the first nodes equals a quantity of the groups of the RTSs. A quantity of the second nodes equal a quantity of the RTSs in each group of the RTSs.

According to other aspects of the present disclosure, the system may include one or more of the following features. The device may further comprise control circuitry configured to (a) set a first one of the second inputs to ground and others of the second inputs to a high resistance mode such that current flows through each RTS connected to a corresponding one of the second nodes connected to the first one of the second inputs. The control circuitry may be configured to (b) measure a voltage at a first one of the first inputs. The control circuitry may be configured to (c) measure a voltage at each of the second inputs. The control circuitry may be configured to (d) determine a current through a corresponding one of the plurality of resistors by subtracting the measured voltage at the first one of the first inputs from the supply voltage and dividing by the known resistance value of the corresponding one of the plurality of resistors. The control circuitry may be configured to (e) repeat (a) through (d) for each subsequent ones of the second inputs. The control circuitry may be configured to (f) determine a resistance value for each RTS whose first end is connected to the respective first node connected to the first one of the first inputs by solving a matrix equation comprising (i) the measured voltages at each of the second inputs for each different one of the second inputs being set to ground, (ii) an unknown conductance value of each RTS whose first end is connected to the respective first node connected to the first one of the first inputs, and (iii) the determined current through the corresponding one of the plurality of resistors. The control circuitry may be further configured to repeat (a) through (f) for each subsequent one of the first inputs and groups of RTSs. Each of the first inputs of the device may comprise an analog-to-digital controller (ADC) and each of the second inputs of the device may comprise a general purpose input. Each of the RTSs may comprise either a negative-temperature-coefficient sensor or a positive-temperature-coefficient sensor. The device may comprise an analog front end.

The foregoing general description of the illustrative embodiments and the following detailed description thereof are merely exemplary aspects of the teachings of this disclosure and are not restrictive.

### BRIEF DESCRIPTION OF FIGURES

The description of the illustrative embodiments may be read in conjunction with the accompanying figures. It will be appreciated that, for simplicity and clarity of illustration, elements illustrated in the figures have not necessarily been drawn to scale, unless described otherwise. For example, the dimensions of some of the elements may be exaggerated relative to other elements, unless described otherwise. Embodiments incorporating teachings of the present disclosure are shown and described with respect to the figures presented herein, in which:

FIG. 1 illustrates a temperature sensing system with multiple resistive temperature sensor groups, according to aspects of the present disclosure;

FIG. 2 illustrates a temperature sensing system with a single resistive temperature sensor group, according to an embodiment;

FIG. 3 illustrates a flowchart for a temperature sensing method, according to aspects of the present disclosure;

FIG. 4 illustrates a flowchart for a temperature sensing method, according to alternative aspects of the present disclosure; and

FIG. 5 illustrates a flowchart for a temperature sensing method, according to alternative aspects of the present disclosure.

### DETAILED DESCRIPTION

Some embodiments of the present disclosure will now be described more fully hereinafter with reference to the accompanying drawings, in which some, but not all embodiments of the disclosure are shown. Indeed, these disclosures may be embodied in many different forms and should not be construed as limited to the embodiments set forth herein; rather, these embodiments are provided so that this disclosure will satisfy applicable legal requirements. Like numbers refer to like elements throughout.

As used herein, terms such as “front,” “rear,” “top,” etc. are used for explanatory purposes in the examples provided below to describe the relative position of certain components or portions of components. Furthermore, as would be evident to one of ordinary skill in the art in light of the present disclosure, the terms “substantially” and “approximately” indicate that the referenced element or associated description is accurate to within applicable engineering tolerances.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” and the like generally mean that the particular feature, structure, or characteristic following the phrase may be included in at least one embodiment of the present disclosure, and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments, or it may be excluded.

Various embodiments of the present disclosure overcome the above technical challenges and difficulties and provide various technical improvements and advantages based on, for example, but not limited to, providing integrated circuits, printed circuit boards (PCBs), systems, devices, and methods for interfacing multiple resistive temperature sensors (RTSs) to an integrated circuit, PCB, device, etc. having fewer inputs than would be needed to connect each temperature sensor to its own separate input. Various embodiments of the present disclosure may be implemented as a BMS AFE or MCU.

The present disclosure relates to a temperature sensing method, a temperature sensing device, and a temperature sensing system for monitoring temperatures using a plurality of resistive temperature sensors (RTSs) arranged in groups. In various applications, such as battery management systems for energy storage systems or automotive applications, monitoring temperature at multiple locations may be desirable. Conventional approaches to temperature monitoring may utilize a dedicated analog-to-digital converter (ADC) channel and a dedicated device pin for each temperature sensor, which may result in a large number of pins being consumed when monitoring many temperature locations.

The temperature sensing method, temperature sensing device, and temperature sensing system described herein may enable temperature monitoring of multiple structures, such as battery cells, using fewer device pins than conventional approaches. In some cases, the RTSs may be arranged in a multiplexed matrix configuration, where multiple RTSs are connected in parallel within each group and multiple groups share common connection nodes. This arrangement may allow a quantity of M multiplied by N resistive temperature sensors to be monitored using M plus N device pins, where M represents a quantity of RTSs in each group and N represents a quantity of groups.

In some cases, the temperature sensing method may involve sequentially grounding individual connection nodes while measuring voltages at other nodes. By performing multiple measurement cycles with different nodes grounded, a system of linear equations may be formed based on Kirchhoff's current law. The temperature sensing device and temperature sensing system may solve these equations to determine the resistance value of each individual RTS, from which temperature values may be derived.

The temperature sensing method, temperature sensing device, and temperature sensing system may eliminate the use of isolation diodes between parallel current paths that may be present in some multiplexed sensor arrangements that have been used. Instead of using diodes to isolate current paths, the temperature sensing method may mathematically account for currents flowing between parallel RTSs by sensing additional voltages and solving matrix equations. This approach may reduce component count and may eliminate accuracy dependencies on diode parameters such as forward voltage.

In some cases, the RTSs may comprise negative-temperature-coefficient (NTC) sensors, where resistance decreases with increasing temperature. In other cases, the RTSs may comprise positive-temperature-coefficient (PTC) sensors, where resistance increases with increasing temperature. The temperature sensing device may comprise an analog front end (AFE) or a microcontroller unit (MCU) having a plurality of first inputs configured as ADCs and a plurality of second inputs configured as general purpose inputs/outputs (GPIOs) or as ADCs. The temperature sensing system may include the RTSs, fixed resistors having known resistance values (one for each group of RTSs), and the temperature sensing device interconnected in the multiplexed matrix configuration.

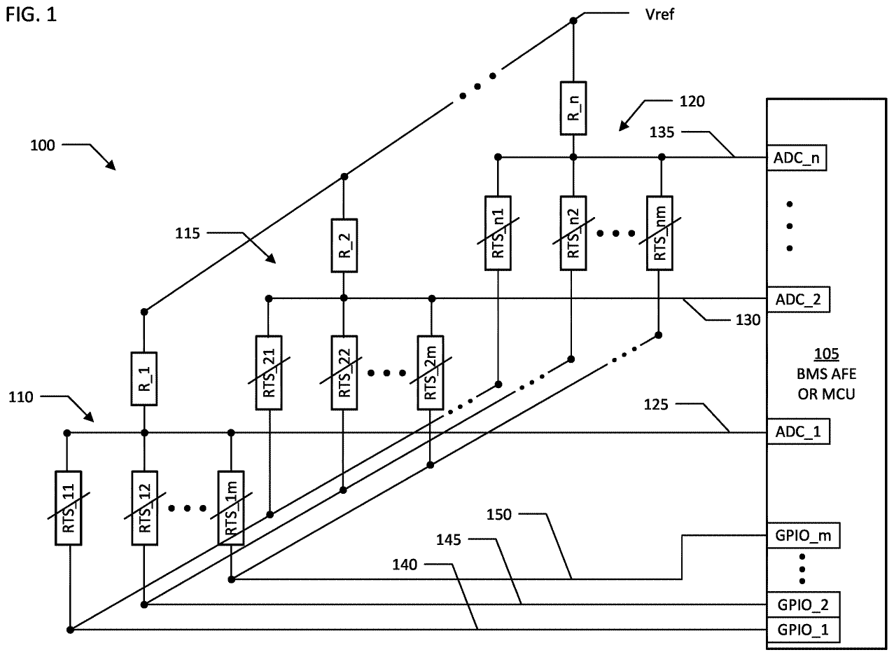

Referring to FIG. 1, a temperature sensing system 100 may be configured for monitoring temperature across multiple resistive temperature sensors (RTSs) in a battery management application or an energy storage system (ESS) application. The temperature sensing system 100 may include a battery management system analog front end 105, which may alternatively be implemented as a microcontroller unit (MCU), along with multiple RTS groups arranged in a matrix configuration.

The temperature sensing system 100 may comprise a plurality of RTS groups including an RTS group 1 110, an RTS group 2 115, and an RTS group n 120, where n represents a total number of RTS groups. Each RTS group may contain multiple resistive temperature sensors arranged in parallel, with each group comprising a same number of RTSs. Each RTS may have a first end and a second end.

With continued reference to FIG. 1, the RTS group 1 110 may include a first RTS RTS_11 in RTS group 1, a second RTS RTS_12 in RTS group 1, and an mth RTS RTS_1m in RTS group 1, where m represents a total number of RTSs in the group. Similarly, the RTS group 2 115 may include a first RTS RTS_21 in RTS group 2, a second RTS RTS_22 in RTS group 2, and an mth RTS RTS_2m in RTS group. The RTS group n 120 may include a first RTS RTS_n1 in RTS group n, a second RTS RTS_n2 in RTS group n, and an mth RTS RTS_nm in RTS group n. In some cases, each of the RTSs may comprise either a negative-temperature-coefficient (NTC) sensor or a positive-temperature-coefficient (PTC) sensor.

In the temperature sensing system 100, each RTS may be positioned adjacent a structure whose temperature is to be determined. In battery management system applications, each RTS may be positioned adjacent to a battery cell to monitor the temperature of the battery cell. In energy storage system applications, the RTSs may similarly be positioned adjacent to battery cells or other components whose temperature monitoring may be desirable.

As further shown in FIG. 1, the battery management system analog front end 105 may include a plurality of first inputs and a plurality of second inputs. The plurality of first inputs may include a first first input ADC_1, a second first input ADC_2, and an nth first input ADC_n, where n represents a total number of first inputs. The first first input ADC_1, the second first input ADC_2, and the nth first input ADC_n may each be configured as an analog-to-digital converter for measuring voltages at respective nodes in the temperature sensing system 100.

The plurality of second inputs of the battery management system analog front end 105 may include a first second input GPIO_1, a second second input GPIO_2, and an mth second input GPIO_m, where m represents a total number of second inputs. The first second input GPIO_1, the second second input GPIO_2, and the mth second input GPIO_m may each be configured as a general purpose input/output that may be selectively set to ground or configured as an ADC input for measuring voltages.

The battery management system analog front end 105 may include control circuitry adapted to determine a resistance of each of the plurality of resistive temperature sensors arranged in the plurality of groups. The control circuitry may be configured to selectively control the first second input GPIO_1, the second second input GPIO_2, and the mth second input GPIO_m to perform measurement cycles, and to process voltage measurements from the first first input ADC_1, the second first input ADC_2, and the nth first input ADC_n to calculate resistance values of the RTSs.

In the temperature sensing method, the plurality of resistive temperature sensors may be arranged in the plurality of groups, with each group comprising the same number of RTSs. Each RTS may be positioned adjacent the structure whose temperature is to be determined, such as a battery cell in a battery management system or energy storage system. The temperature sensing device may include the plurality of first inputs and the plurality of second inputs, along with the control circuitry adapted to determine the resistance of each RTS. The temperature sensing system may include the plurality of resistive temperature sensors arranged in the plurality of groups, with each RTS adapted to be positioned adjacent the structure whose temperature is to be determined.

In the temperature sensing system 100, for each group of RTSs, the first end of each RTS in a same group may be connected to a respective one of a plurality of first nodes. The RTS group 1 110 may be connected to a first first node 125, where the first end of the first RTS RTS_11 in RTS group 1, the first end of the second RTS RTS_12 in RTS group 1, and the first end of the mth RTS RTS_1m in RTS group 1 may each be connected to the first first node 125. The RTS group 2 115 may be connected to a second first node 130, where the first end of each RTS in the RTS group 2 115 may be connected to the second first node 130. The RTS group n 120 may be connected to an nth first node 135, where the first end of each RTS in the RTS group n 120 may be connected to the nth first node 135. A quantity of the first nodes may equal a quantity of the groups of the RTSs.

The temperature sensing system 100 may include a plurality of resistors each having a fixed, known resistance value. A first end of each of the plurality of resistors may be connected to a supply voltage Vref and a second end of each of the plurality of resistors may be connected to the first node of a respective group of RTSs. A fixed known resistor R_1 for RTS group 1 may have a first end connected to the supply voltage Vref and a second end connected to the first first node 125. A fixed known resistor R_2 for RTS group 2 may have a first end connected to the supply voltage Vref and a second end connected to the second first node 130. A fixed known resistor R_n for RTS group n may have a first end connected to the supply voltage Vref and a second end connected to the nth first node 135. A quantity of the resistors may equal a quantity of the groups of the RTSs.

In the temperature sensing method, connecting a first end of each of the plurality of resistors each having the fixed, known resistance value to the supply voltage and the second end of each of the plurality of resistors to the first node of the respective group of RTSs may enable current measurement through voltage sensing. In the temperature sensing device, the control circuitry may be adapted to determine the resistance of each RTS based on voltage measurements at the first nodes and the known resistance values of the fixed known resistor R_1 for RTS group 1, the fixed known resistor R_2 for RTS group 2, and the fixed known resistor R_n for RTS group n.

The fixed known resistor R_1 for RTS group 1, the fixed known resistor R_2 for RTS group 2, and the fixed known resistor R_n for RTS group n may each have a resistance value of 10K ohms, for example. In some cases, the fixed known resistor R_1 for RTS group 1, the fixed known resistor R_2 for RTS group 2, and the fixed known resistor R_n for RTS group n may each have a resistance value of 4K ohms to improve measurement accuracy. The selection of the resistance value for the fixed known resistors may affect the voltage range and current levels in the temperature sensing system 100, and a lower resistance value such as 4K ohms may provide improved accuracy in some operating conditions.

The temperature sensing system 100 may include filter resistors (not illustrated) connected to the first nodes to filter out noise. The filter resistors may be connected to the first first node 125, the second first node 130, and the nth first node 135. The temperature sensing system 100 may also include filter capacitors (not illustrated) connected to the first nodes to filter out noise. The filter capacitors may be connected to the first first node 125, the second first node 130, and the nth first node 135. The filter resistors and the filter capacitors may form low-pass filter circuits that attenuate high-frequency noise on the first nodes, which may improve the accuracy of voltage measurements performed by the battery management system analog front end 105.

In the temperature sensing system 100, the second end of each RTS may be connected to the second end of one respective RTS in each other group of RTSs via a respective one of a plurality of second nodes. A first second node 140 may connect the second end of the first RTS RTS_11 in RTS group 1 to the second end of the first RTS RTS_21 in RTS group 2 and to the second end of the first RTS RTS_n1 in RTS group n. A second second node 145 may connect the second end of the second RTS RTS_12 in RTS group 1 to the second end of the second RTS RTS_22 in RTS group 2 and to the second end of the second RTS RTS_n2 in RTS group n. An mth second node 150 may connect the second end of the mth RTS RTS_1m in RTS group 1 to the second end of the mth RTS RTS_2m in RTS group 2 and to the second end of the mth RTS RTS_nm in RTS group n.

Each of the second nodes may be connected to a respective second input of the battery management system analog front end 105. The first second node 140 may be connected to the first second input GPIO_1. The second second node 145 may be connected to the second second input GPIO_2. The mth second node 150 may be connected to the mth second input GPIO_m. A quantity of the second nodes may equal a quantity of the RTSs in each group of the RTSs. In the temperature sensing system 100, where each group contains m RTSs, the temperature sensing system 100 may include m second nodes.

In the temperature sensing method, connecting the second end of each RTS to the second end of one respective RTS in each other group of RTSs via a respective one of the plurality of second nodes may establish the multiplexed matrix configuration. Connecting each of the second nodes to a respective second input of the device may enable selective grounding of individual second nodes during measurement cycles. In the temperature sensing device, the control circuitry may be adapted to determine the resistance of each RTS based on the connections where the second end of each RTS is connected to the second end of one respective RTS in each other group of RTSs via a respective one of the plurality of second nodes, and where each of the second nodes is connected to a respective second input of the device.

The temperature sensing system 100 may include ESD protection capacitors (not illustrated) connected to the second nodes to protect against electrostatic discharge. An ESD protection capacitor may be connected to the first second node 140, the second second node 145, and the mth second node 150. The ESD protection capacitors may provide a low-impedance path to ground for high-frequency transients associated with electrostatic discharge events, thereby protecting the first second input GPIO_1, the second second input GPIO_2, and the mth second input GPIO_m of the battery management system analog front end 105.

The temperature sensing system 100 may include GPIO protection resistors (not illustrated) connected in series with the second nodes to protect against ESD strikes and surges. A GPIO protection resistor may be connected in series between the first second node 140 and the first second input GPIO_1, between the second second node 145 and the second second input GPIO_2, and between the mth second node 150 and the mth second input GPIO_m. The GPIO protection resistors may limit current flow during ESD strikes and surges, thereby protecting the first second input GPIO_1, the second second input GPIO_2, and the mth second input GPIO_m from damage.

In the temperature sensing method, connecting each of the first nodes to a respective first input of a device having a plurality of first inputs and a plurality of second inputs may establish the measurement interface between the RTS groups and the device. The first first node may be connected to the first first input, the second first node may be connected to the second first input, and the nth first node may be connected to the nth first input.

The device may include a VTREF node that serves as both an NTC supply voltage and is internally multiplexed to a fully differential ADC. The VTREF node may provide the supply voltage to the fixed known resistors, and the VTREF node may also be connected to an internal multiplexer that routes the VTREF node to a fully differential ADC for voltage measurement. The fully differential ADC connected to the VTREF node may measure a voltage difference between the VTREF node and the first nodes, which may enable determination of the voltage drop across the fixed known resistors.

The first inputs may be multiplexed to fully differential ADCs capable of measuring voltage differences between the first nodes and the second nodes. The fully differential ADCs may measure a voltage at a first node relative to a voltage at a second node, which may provide a measurement of the voltage across an RTS connected between the first node and the second node. The fully differential measurement capability may reduce common-mode noise and may improve measurement accuracy compared to single-ended measurements.

The second inputs may comprise open-drain switches that connect a respective pin to ground when activated. When an open-drain switch of a second input is activated, the open-drain switch may provide a low-impedance path from the corresponding second node to ground, which may cause current to flow through each RTS connected to the corresponding second node. When the open-drain switch is deactivated, the second input may be configured in a high-impedance state or may be configured as an ADC input for measuring the voltage at the corresponding second node. The open-drain configuration may allow the second inputs to selectively ground individual second nodes during measurement cycles while allowing voltage measurement at the second nodes when the open-drain switches are deactivated.

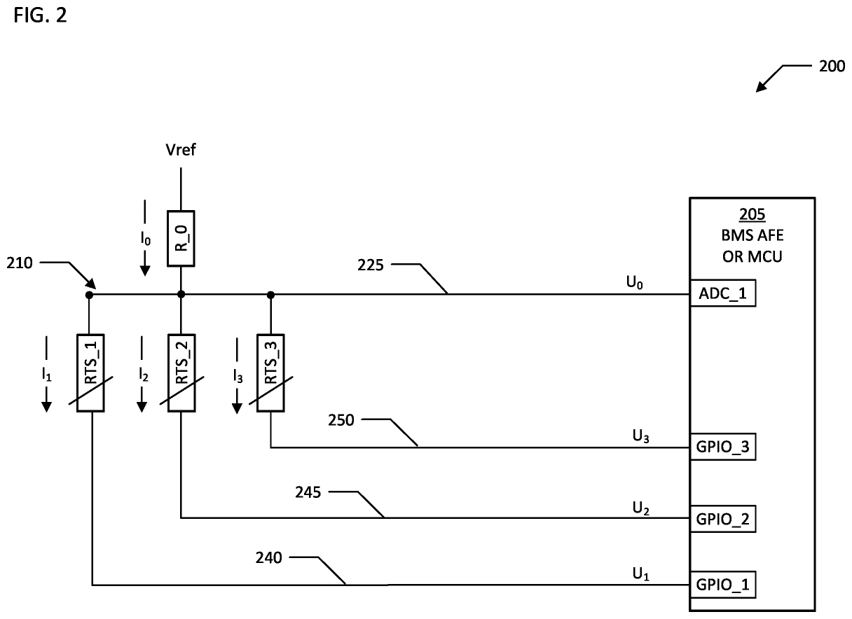

Referring to FIG. 2, a temperature sensing system 200 may be configured for measuring resistance values of multiple resistive temperature sensors connected in a multiplexed arrangement. The temperature sensing system 200 may illustrate a single group configuration that demonstrates the measurement principles applied in the temperature sensing system 100 of FIG. 1. The temperature sensing system 200 may include a battery management system analog front end 205, which may alternatively be implemented as a microcontroller unit (MCU), connected to an RTS group 210 containing multiple resistive temperature sensors.

The temperature sensing system 200 may include a fixed known resistor R_0 connected between a reference voltage Vref and a first node 225. The fixed known resistor R_0 may have a fixed, known resistance value that enables current determination through voltage measurement. A current I₀ through R_0 may flow from the reference voltage Vref through the fixed known resistor R_0 toward the first node 225. The current I₀ through R_0 may be determined by measuring a voltage at the first node 225, subtracting the measured voltage from the reference voltage Vref, and dividing by the known resistance value of the fixed known resistor R_0.

With continued reference to FIG. 2, the first node 225 may serve as a common connection point for the RTS group 210 and may be coupled to a first first input ADC_1 of the battery management system analog front end 205. The first first input ADC_1 may measure a voltage U₀ at the first node 225. The voltage U₀ at the first node 225 may vary depending on which second input is grounded during a measurement cycle, as the grounding of different second inputs may change the current distribution through the RTSs in the RTS group 210.

The RTS group 210 may comprise three resistive temperature sensors arranged in parallel between the first node 225 and respective second nodes. A first RTS RTS_1 may be connected between the first node 225 and a first second node 240, with a current I₁ through RTS_1 flowing through the first RTS RTS_1. A second RTS RTS_2 may be connected between the first node 225 and a second second node 245, with a current I₂ through RTS_2 flowing through the second RTS RTS_2. A third RTS RTS_3 may be connected between the first node 225 and a third second node 250, with a current I₃ through RTS_3 flowing through the third RTS RTS_3.

As further shown in FIG. 2, the first second node 240 may be coupled to a first second input GPIO_1 of the battery management system analog front end 205, the second second node 245 may be coupled to a second second input GPIO_2, and the third second node 250 may be coupled to a third second input GPIO_3. The first second input GPIO_1, the second second input GPIO_2, and the third second input GPIO_3 may each be configurable as either an output set to a low state for grounding the connected RTS, or as an analog-to-digital converter input for measuring voltages at the respective second nodes.

The first RTS RTS_1, the second RTS RTS_2, and the third RTS RTS_3 may each have a characteristic resistance at a reference temperature. The reference temperature TO may be, for example, 25 degrees Celsius. The first RTS RTS_1, the second RTS RTS_2, and the third RTS RTS_3 may each have a beta coefficient that defines a resistance-temperature relationship. The resistance of each RTS at a given temperature may be determined based on the characteristic resistance, the reference temperature, and the beta coefficient according to an exponential relationship. The nominal resistance value and the beta coefficient may be parameters specified by a manufacturer of the RTSs. The temperature sensing system 200 may utilize the nominal resistance value and the beta coefficient to convert measured resistance values to temperature values.

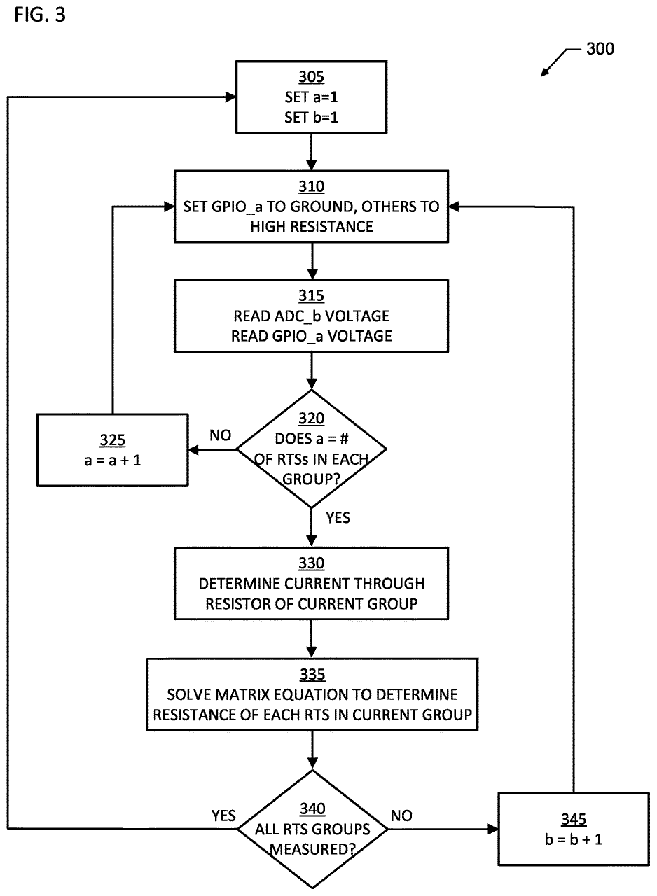

Referring to FIG. 3, a temperature sensing method 300 may be performed by the temperature sensing system 100 of FIG. 1 or the temperature sensing system 200 of FIG. 2, although the temperature sensing system 200 of FIG. 2 is specifically described in relation to FIG. 3. The temperature sensing method 300 may provide a systematic approach for sequentially grounding each GPIO, measuring voltages, and solving matrix equations based on Kirchhoff's current law to determine the resistance values of multiple RTSs arranged in groups.

The temperature sensing method 300 may begin with step 305, where variables a and b may be initialized by setting a=1 and b=1. The variable a may represent an index for the second inputs, where a=1 corresponds to the first second input GPIO_1, a=2 corresponds to the second second input GPIO_2, a=3 corresponds to the third second input GPIO_3, and so forth up to the total number of RTSs in each group. The variable b may represent an index for the first inputs and corresponding RTS groups, where b=1 corresponds to the first first input ADC_1 and the RTS group 1 110, b=2 corresponds to a second first input and a second RTS group (not illustrated in FIG. 3), and so forth up to the total number of groups.

With continued reference to FIG. 3, the temperature sensing method 300 may proceed to step 310, where GPIO_a may be set to ground while other GPIOs may be set to a high resistance mode. In the temperature sensing method, setting a first one of the second inputs to ground and others of the second inputs to a high resistance mode may cause current to flow through each RTS connected to a corresponding one of the second nodes connected to the first one of the second inputs. When the first second input GPIO_1 is set to ground and the second second input GPIO_2 and the third second input GPIO_3 are set to the high resistance mode, current may flow through each RTS whose second end is connected to the first second node 140.

The high resistance mode may configure the second inputs that are not grounded as floating inputs or as high-impedance inputs. When a second input is in the high resistance mode, the second input may not sink or source current, which may allow the voltage at the corresponding second node to be determined by the current flowing through the RTSs connected to that second node. The high resistance mode may also allow the second inputs to be configured as ADC inputs for measuring voltages at the corresponding second nodes.

As further shown in FIG. 3, the temperature sensing method 300 may proceed to step 315, where the voltage at the first first input (ADC_1 in FIG. 2) voltage may be read, which corresponds to the voltage at the first first node 125. Additionally, the voltage at all the GPIO inputs (GPIO_1, GPIO_2, and GPIO_3 in FIG. 2) may be read, which correspond respectively to the voltage at the first second node 240, the second second node 245, and the third second node 250.

When the first second input GPIO_1 is set to ground, the voltage at the first second input GPIO_1 may be zero, while the voltages at the second second input GPIO_2 and the third second input GPIO_3 may be non-zero values determined by the current distribution through the RTSs.

As illustrated in FIG. 2, the voltage measurements at step 315 may include measuring the voltage U₀ at the first node 225 using the first first input ADC_1, measuring the voltage U₁ at the first second node 240, measuring the voltage U₂ at the second second node 245, and measuring the voltage U₃ at the third second node 250.

Returning to FIG. 3, the temperature sensing method 300 may proceed to step 320, where a determination may be made as to whether a equals the number of RTSs in each group. The variable a may represent the current index of the second input being processed, and the number of RTSs in each group may correspond to the value m, which represents the total quantity of RTSs in each RTS group. At step 320, the temperature sensing method 300 may compare the current value of a to the value m to determine whether all second inputs have been processed for the current measurement cycle.

If a does not equal the number of RTSs in each group at step 320, the temperature sensing method 300 may proceed to step 325, where a may be incremented by 1 (a=a+1). After incrementing a at step 325, the temperature sensing method 300 may return to step 310 to repeat the measurement process with the next second input with a different second input set to ground while the other second inputs are set to a high resistance mode.

The iterative process through step 310, step 315, step 320, and step 325 may continue until all second inputs have been sequentially grounded and corresponding voltage measurements have been obtained. When a=1, the first second input GPIO_1 may be grounded and voltages may be measured. When a=2, the second second input GPIO_2 may be grounded and voltages may be measured. When a=3, the third second input GPIO_3 may be grounded and voltages may be measured. After each iteration, step 320 may determine whether additional second inputs remain to be processed.

If a equals the number of RTSs in each group at step 320, the temperature sensing method 300 may proceed to step 330, where the current (I₀ in FIG. 2) through the resistor (R_0 in FIG. 2) of the current RTS group (210 in FIG. 2) may be determined. The current through the resistor of the current RTS group is determined by subtracting the measured voltage at the first one of the first inputs from the supply voltage and dividing the result by the known resistance value of the resistor of the current RTS group.

The current through the fixed known resistor may be calculated using the formula

$${I}_{0} = \frac{{V}_{ref} - {U}_{0}}{{R}_{0}} ,$$

where I₀ represents the current through the fixed known resistor, Vref represents the supply voltage, U_0 represents the measured voltage at the first node, and R_0 represents the known resistance value of the fixed known resistor. The current I₀ may be determined for each measurement cycle where a different second input is grounded, resulting in current values I_{0A}, I_{0B}, and loc corresponding to measurement cycles A, B, and C respectively.

For each measurement cycle, the measured voltage at the first node may vary depending on which second input is grounded, as the grounding of different second inputs may change the current distribution through the RTSs in the RTS group. The current through the fixed known resistor may therefore be different for each measurement cycle. The current values determined at step 330 may be used in subsequent matrix equation solving to determine the resistance values of the individual RTSs.

The temperature sensing method 300 may proceed to step 335, where a matrix equation may be solved to determine the resistance of each RTS in the current group. In various embodiments, the matrix equation that is solved comprises (i) the measured voltages at each of the second inputs for each different one of the second inputs being set to ground, (ii) an unknown conductance (which is the inverse of resistance) value of each RTS, and (iii) the determined current through the corresponding resistor for each different one of the second inputs being set to ground.

The RTS conductance or resistance values may be calculated using Kirchhoff's current law where the sum of all currents at a node equals zero. For the RTS group 210 of FIG. 2 containing three RTSs, the Kirchhoff current law relationship may be expressed as I₁+I₂+I₃−I₀=0, where I₁ represents the current through the first RTS, I₂ represents the current through the second RTS, I₃ represents the current through the third RTS, and I₀ represents the current through the fixed known resistor. The Kirchhoff current law relationship may indicate that the current flowing into the first node through the fixed known resistor equals the sum of the currents flowing out of the first node through the individual RTSs.

The matrix equation may be formulated based on the Kirchhoff current law relationship applied to each measurement cycle. For three measurement cycles A, B, and C where different second inputs are sequentially grounded, the matrix equation may be expressed as:

$$( \begin{matrix}{U}_{1 A} & {U}_{2 A} & {U}_{3 A} \\ {U}_{1 B} & {U}_{2 B} & {U}_{3 B} \\ {U}_{1 C} & {U}_{1 C} & {U}_{3 C}\end{matrix} ) ( \begin{matrix}\frac{1}{{R}_{1}} \\ \frac{1}{{R}_{2}} \\ \frac{1}{{R}_{3}}\end{matrix} ) = ( \begin{matrix}{I}_{0 A} \\ {I}_{0 B} \\ {I}_{0 C}\end{matrix} ) .$$

In the matrix equation, U_{1A}, U_{2A}, and U_{3A} represent the measured voltages at each of the second inputs when the first second input is set to ground during measurement cycle A; U_{1B}, U_{2B}, and U_{3B} represent the measured voltages at each of the second inputs when the second second input is set to ground during measurement cycle B; and U_{1C}, U_{2C}, and U_{3C} represent the measured voltages at each of the second inputs when the third second input is set to ground during measurement cycle C. The terms

$$\frac{1}{{R}_{1}} , \frac{1}{{R}_{2}} ,$$

and

$$\frac{1}{{R}_{3}}$$

represent the unknown conductance values of each RTS whose first end is connected to the respective first node. The terms I_{0A}, I_{0B}, and I_{0C} may represent the determined current through the fixed known resistor for each measurement cycle. Any suitable technique may be used to solve the matrix equation.

For example, the matrix equation solving may use substitution variables K_{0B}, K_{0C}, K_{2B}, K_{2C}, K_{3B}, and K_{3C} derived from ratios of measured voltages and currents to simplify the calculation. The substitution variable K_{0B} may be defined as

$${K}_{0 B} = \frac{{I}_{0 A}}{{U}_{1 A}} - \frac{{I}_{0 B}}{{U}_{1 B}} .$$

The substitution variable K_{0C} may be defined as

$${K}_{0 C} = \frac{{I}_{0 A}}{{U}_{1 A}} - \frac{{I}_{0 C}}{{U}_{1 C}} .$$

The substitution variable K_{2B} may be defined as

$${K}_{2 B} = \frac{{U}_{2 A}}{{U}_{1 A}} - \frac{{U}_{2 B}}{{U}_{1 B}} .$$

The substitution variable K_{2C} may be defined as

$${K}_{2 C} = \frac{{U}_{2 A}}{{U}_{1 A}} - \frac{{U}_{2 C}}{{U}_{1 C}} .$$

The substitution variable K_{3B} may be defined as

$${K}_{3 B} = \frac{{U}_{3 A}}{{U}_{1 A}} - \frac{{U}_{3 B}}{{U}_{1 B}} .$$

The substitution variable K_{3C} may be defined as

$${K}_{3 C} = \frac{{U}_{3 A}}{{U}_{1 A}} - \frac{{U}_{3 C}}{{U}_{1 C}} .$$

Using the substitution variables, the resistance R₃ of the third RTS may be calculated as

$${R}_{3} = \frac{{K}_{3 C} \cdot {K}_{2 B} - {K}_{3 B} \cdot {K}_{2 C}}{{K}_{0 C} \cdot {K}_{2 B} - {K}_{0 B} \cdot {K}_{2 C}} .$$

The resistance R₂ of the second RTS may be calculated as

$${R}_{2} = \frac{{K}_{2 B}}{{K}_{0 B} - \frac{{K}_{3 B}}{{R}_{3}}} .$$

The resistance R₁ of the first RTS may be calculated as

$${R}_{1} = \frac{{U}_{1 A}}{{I}_{0 A} - \frac{{U}_{2 A}}{{R}_{2}} - \frac{{U}_{3 A}}{{R}_{3}}} .$$

The temperature sensing system may be implemented using a Gauss method-based divider circuit to solve the matrix equations for determining RTS resistance values. The Gauss method-based divider circuit may perform row reduction operations on the matrix to transform the matrix into an upper triangular form, from which the unknown conductance values may be determined through back substitution. In some cases, the temperature sensing system may be implemented using a neutral zone divider circuit to solve the matrix equations for determining RTS resistance values. The neutral zone divider circuit may provide an alternative hardware implementation for solving the system of linear equations represented by the matrix equation.

The temperature sensing method may process multiple RTS groups in parallel when sufficient analog-to-digital converters are available. When the battery management system analog front end includes a sufficient number of ADCs, the voltage measurements for multiple RTS groups may be performed simultaneously, and the matrix equations for multiple RTS groups may be solved in parallel. In some cases, the temperature sensing method may process multiple RTS groups serially by iterating through each group sequentially. When the battery management system analog front end includes a limited number of ADCs, the voltage measurements and matrix equation solving may be performed for one RTS group at a time, with the process repeated for each subsequent RTS group.

The temperature sensing method 300 may proceed to step 340, where a determination may be made as to whether all RTS groups have been measured. Step 340 may compare the current value of b to the total number n of RTS groups to determine whether resistance values have been determined for all RTSs in all RTS groups in the temperature sensing system 100. When b equals n, all RTS groups have been processed, and the temperature sensing method 300 may terminate.

If all RTS groups have not been measured at step 340, the temperature sensing method 300 may proceed to step 345, where b may be incremented by 1 (b=b+1). After incrementing b at step 345, the temperature sensing method 300 may return to step 305 to begin processing the next RTS group. When b is incremented from 1 to 2, the temperature sensing method 300 may process a second RTS group connected to a second first node and a second first input. When b is incremented from 2 to 3, the temperature sensing method 300 may process a subsequent RTS group connected to a corresponding first node and first input. The repetition may continue until resistance values have been determined for each RTS in each RTS group of the temperature sensing system 100.

Various other embodiments of the present disclosure involve switching a single GPIO and measuring all ADC channels before moving to the next GPIO. This reduces the number of GPIO switchings (e.g., to three in the 3×3 example described herein), with all other measurements calculated from these readings. This approach is more efficient and reduces switching time.

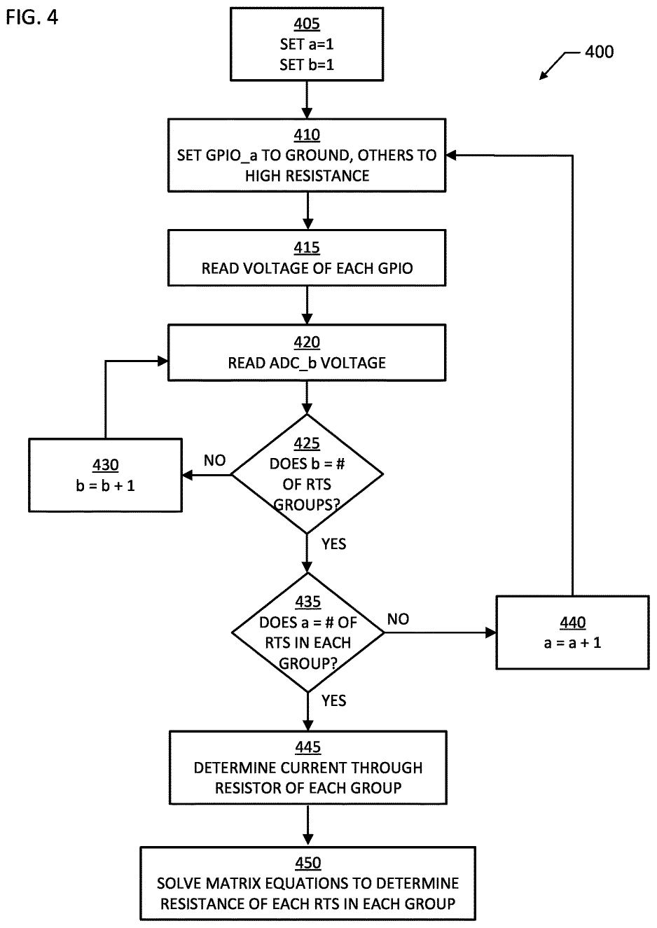

Referring to FIG. 4, an alternative temperature sensing method 400 is illustrated. The temperature sensing method 400 may begin with step 405, where variables a and b may be initialized by setting a=1 and b=1. The variable a may represent an index for the second inputs and the variable b may represent an index for the first inputs and corresponding RTS groups, as described above with FIG. 3.

The temperature sensing method 400 may proceed to step 410, where the first second input (GPIO_a) may be set to ground while other GPIOs may be set to a high resistance mode. The temperature sensing method 400 may proceed to step 415, where the voltage at each of the GPIO inputs (GPIO_1, GPIO_2, and GPIO_3 in FIG. 2) may be read. When the first second input GPIO_1 is set to ground, the voltage at the first second input GPIO_1 may be zero, while the voltages at the second second input GPIO_2 and the third second input GPIO_3 may be non-zero values determined by the current distribution through the RTSs.

The temperature sensing method 400 may proceed to step 420, where the voltage at the first first input (ADC_b) voltage may be measured. The temperature sensing method 400 may proceed to step 425, where a determination may be made as to whether b equals the number of RTS groups, indicating whether the voltage at all of the first inputs has been measured. If the voltage at all of the first inputs has not been measured at step 420, the temperature sensing method 400 may proceed to step 430, where b may be incremented by 1 (b=b+1). After incrementing b at step 430, the temperature sensing method 400 may return to step 420 to measure the voltage at the next first input. The repetition may continue until a voltage has been measured at each first input.

If the voltage at all of the first inputs has been measured, the temperature sensing method 400 may proceed to step 435 where a determination may be made as to whether a equals the number of RTSs in each group, indicating whether the voltages at all of the first inputs have been measured with each of the second inputs being set to ground.

If a does not equal the number of RTSs in each group, the temperature sensing method 400 may proceed to step 440, where a may be incremented by 1 (a=a+1). After incrementing a at step 440, the temperature sensing method 400 may return to step 410 to repeat the measurement process with a different second input set to ground while the other second inputs are set to a high resistance mode. The iterative process of step 410 through step 435 may continue until all second inputs have been sequentially grounded and corresponding voltage measurements have been obtained at each first input.

If a equals the number of RTSs in each group at step 435, the temperature sensing method 400 may proceed to step 445, where the current through the resistor of each RTS group may be determined as described above. The temperature sensing method 400 may proceed to step 450, where a matrix equation may be solved to determine the resistance of each RTS in each group, as described above.

Various other embodiments of the present disclosure involve measuring differential voltages directly rather than calculating them from single-ended ADC measurements. Such embodiments require either fully differential ADCs or pairs of single-ended ADCs to measure differences between ADC inputs and GPIOs, improving accuracy by avoiding the accumulation of measurement errors from separate ADC readings. Fully differential ADCs measure voltage differences directly between two inputs, which reduces the effect of parasitic resistances and improves measurement precision. Alternatively, using two single-ended ADCs and calculating the difference in software can achieve similar results but with potentially lower accuracy and increased complexity.

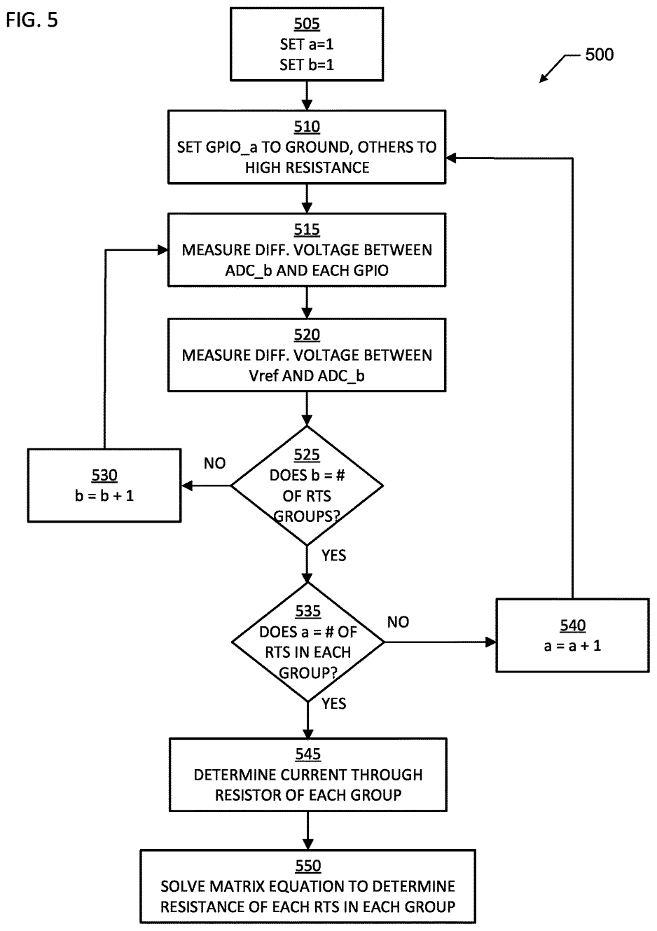

Referring to FIG. 5, an alternative temperature sensing method 500 is illustrated. The temperature sensing method 500 may begin with step 505, where variables a and b may be initialized by setting a=1 and b=1. The variable a may represent an index for the second inputs and the variable b may represent an index for the first inputs and corresponding RTS groups, as described above with FIG. 3.

The temperature sensing method 500 may proceed to step 510, where the first second input (GPIO_a) may be set to ground while other GPIOs may be set to a high resistance mode. The temperature sensing method 500 may proceed to step 515, where a differential voltage is measured between the first first input (ADC_b) and each GPIO. The temperature sensing method 500 may proceed to step 520, where a differential voltage is measured between Vref and ADC_b.

The temperature sensing method 500 may proceed to step 525, where a determination may be made as to whether b equals the number of RTS groups, indicating whether differential voltages have been measured for all of the first inputs. If it is determined at step 525 that differential voltages have not been measured for all of the first inputs, the temperature sensing method 500 may proceed to step 530, where b may be incremented by 1 (b=b+1). After incrementing b at step 530, the temperature sensing method 500 may return to step 515 and 520. The repetition may continue until differential voltages have been measured for all of the first inputs.

If it is determined at step 525 that differential voltages have been measured for all of the first inputs, the temperature sensing method 500 may proceed to step 535 where a determination may be made as to whether a equals the number of RTSs in each group, indicating whether differential voltages have been measured with each of the second inputs being set to ground.

If a does not equal the number of RTSs in each group, the temperature sensing method 500 may proceed to step 540, where a may be incremented by 1 (a=a+1). After incrementing a at step 540, the temperature sensing method 500 may return to step 510 to repeat the measurement process with a different second input set to ground while the other second inputs are set to a high resistance mode. The iterative process of step 510 through step 535 may continue until all second inputs have been sequentially grounded and corresponding differential voltage measurements have been obtained at each first input.

If a equals the number of RTSs in each group at step 535, the temperature sensing method 500 may proceed to step 545, where the current through the resistor of each RTS group may be determined as described above. The temperature sensing method 500 may proceed to step 550, where a matrix equation may be solved to determine the resistance of each RTS in each group, as described above.

When using differential ADCs, as described in FIG. 5, the directly measured ADCs (a total of n+m channels) are (referring to FIG. 1):
V_R_1, V_R_2, . . . . V_R_n (a total of n channels); and
V_RTS_11, V_RTS_12, V_RTS_1m (a total of m channels).
   Then, the calculated ADCs (a total of (n−1)*m channels) are:
V_RTS_21=V_R_1+V_RTS_11−V_R_2;
V_RTS_22=V_R_1+V RTS_12−V_R_2;
. . .

The temperature sensing system of various embodiments may be implemented with digital logic circuitry embedded within an integrated circuit to automatically solve the matrix equations. The digital logic circuitry may perform the matrix equation solving operations described at step 335 without requiring external processing resources. The digital logic circuitry may include arithmetic units configured to perform the division, multiplication, and subtraction operations used in calculating the substitution variables and resistance values. The digital logic circuitry may be integrated within the battery management system analog front end to provide an automated temperature sensing solution.

In some cases, the temperature sensing system may be implemented with an external microcontroller performing the matrix equation calculations. The external microcontroller may receive voltage measurement data from the battery management system analog front end and may execute software instructions to solve the matrix equations described at step 335. The external microcontroller may provide flexibility in implementing different matrix solving algorithms and may allow updates to the calculation methodology through software modifications.

The temperature sensing system may use external open-drain field-effect transistors (FETs) connected to the second nodes instead of integrated GPIO switches to provide the grounding function described at step 310. The external open-drain FETs may be controlled by the battery management system analog front end 105 or by an external microcontroller to selectively ground individual second nodes during measurement cycles. The use of external open-drain FETs may allow the temperature sensing method to be implemented with devices that do not include integrated GPIO switches capable of grounding the second nodes.

The temperature sensing system may provide reduced pin count requirements compared to conventional temperature sensing approaches. In conventional approaches, each resistive temperature sensor may require a dedicated analog-to-digital converter channel and a dedicated device pin, resulting in a one-to-one correspondence between temperature sensors and device pins. The temperature sensing system described herein may enable M multiplied by N resistive temperature sensors to be monitored using M plus N device pins, where M represents a quantity of RTSs in each group and N represents a quantity of groups. For a configuration with three RTSs per group and three groups, the temperature sensing system may monitor nine resistive temperature sensors using six device pins, compared to nine device pins that may be consumed in a conventional approach.

The reduced pin count requirements may enable temperature monitoring of a larger number of locations using a device with a fixed number of available pins. In battery management system applications, the reduced pin count requirements may allow a battery management system analog front end to monitor temperature at an increased number of battery cell location without exceeding the available pin count of the device. The reduced pin count requirements may also enable the use of smaller device packages with fewer pins, which may reduce the physical size and cost of the battery management system analog front end.

The temperature sensing system may provide cost savings through elimination of external analog multiplexer components. The temperature sensing system may provide cost savings through elimination of isolation diodes between parallel current paths. The temperature sensing system may enable compliance with safety standards that require temperature monitoring at each battery cell location. The temperature sensing system may enable compliance with safety standards without increasing hardware complexity compared to conventional approaches that share temperature sensors between multiple battery cells.

### CONCLUSION

Many modifications and other embodiments of the disclosures set forth herein will come to mind to one skilled in the art to which these disclosures pertain having the benefit of teachings presented in the foregoing descriptions and the associated drawings. Although the figures only show certain components of the apparatus and systems described herein, it is understood that various other components may be used in conjunction with the system. Therefore, it is to be understood that the disclosures are not to be limited to the specific embodiments disclosed and that modifications and other embodiments are intended to be included within the scope of the appended claims. Moreover, steps in the method described above may not necessarily occur in the order depicted in the accompanying diagrams, and in some cases one or more of steps depicted may occur substantially simultaneously, or additional steps may be involved. Although specific terms are employed herein, they are used in a generic and descriptive sense only and not for purposes of limitation.

While various embodiments in accordance with the principles disclosed herein have been shown and described above, modifications thereof may be made by one skilled in the art without departing from the spirit and the teachings of the disclosure. The embodiments described herein are representative only and are not intended to be limiting. Many variations, combinations, and modifications are possible and are within the scope of the disclosure. Alternative embodiments that result from combining, integrating, and/or omitting features of the embodiment(s) are also within the scope of the disclosure. Accordingly, the scope of protection is not limited by the description set out above.

Additionally, the section headings used herein are provided for consistency with the suggestions under 37 C.F.R. 1.77 or to otherwise provide organizational cues. These headings shall not limit or characterize the disclosure(s) set out in any claims that may issue from this disclosure.

While this detailed description has set forth some embodiments of the present disclosure, the appended claims cover other embodiments of the present disclosure which differ from the described embodiments according to various modifications and improvements. For example, the appended claims can cover any form of system or device for monitoring a plurality of sensors, particularly temperature sensors, and more particularly resistive temperature sensors.

Within the appended claims, unless the specific term “means for” or “step for” is used within a given claim, it is not intended that the claim be interpreted under 35 U.S.C. 112, paragraph 6.

What is claimed is:

1. A temperature sensing method comprising:
arranging a plurality of resistive temperature sensors (RTSs) in a plurality of groups, each group comprising a same number of RTSs, each RTS having a first end and a second end;
positioning each RTS adjacent a structure whose temperature is to be determined;
for each group of RTSs, connecting the first end of each RTS in a same group to a respective one of a plurality of first nodes;
connecting a first end of each of a plurality of resistors each having a fixed, known resistance value to a supply voltage and a second end of each of the plurality of resistors to the first node of a respective group of RTSs;
connecting the second end of each RTS to the second end of one respective RTS in each other group of RTSs via a respective one of a plurality of second nodes;
connecting each of the first nodes to a respective first input of a device having a plurality of first inputs and a plurality of second inputs; and
connecting each of the second nodes to a respective second input of the device;
wherein a quantity of the resistors equals a quantity of the groups of the RTSs;
wherein a quantity of the first nodes equals a quantity of the groups of the RTSs; and
wherein a quantity of the second nodes equal a quantity of the RTSs in each group of the RTSs.

2. The method of claim 1, further comprising:
(a) setting a first one of the second inputs to ground and others of the second inputs to a high resistance mode such that current flows through each RTS connected to a corresponding one of the second nodes connected to the first one of the second inputs;
(b) measuring a voltage at a first one of the first inputs;
(c) measuring a voltage at each of the second inputs;
(d) determining a current through a corresponding one of the plurality of resistors by subtracting the measured voltage at the first one of the first inputs from the supply voltage and dividing by the known resistance value of the corresponding one of the plurality of resistors;
(e) repeating (a) through (d) for each subsequent ones of the second inputs; and
(f) determining a resistance value for each RTS whose first end is connected to the respective first node connected to the first one of the first inputs by solving a matrix equation comprising (i) the measured voltages at each of the second inputs for each different one of the second inputs being set to ground, (ii) an unknown conductance value of each RTS whose first end is connected to the respective first node connected to the first one of the first inputs, and (iii) the determined current through the corresponding one of the plurality of resistors.

3. The method of claim 2, further comprising repeating (a) through (f) for each subsequent one of the first inputs and groups of RTSs.

4. The method of claim 1, wherein each of the first inputs of the device comprises an analog-to-digital controller (ADC) and each of the second inputs of the device comprises a general purpose input.

5. The method of claim 1, wherein each of the RTSs comprise either a negative-temperature-coefficient sensor or a positive-temperature-coefficient sensor.

6. The method of claim 1, further comprising:
(a) setting a first one of the second inputs to ground and others of the second inputs to a high resistance mode such that current flows through each RTS connected to a corresponding one of the second nodes connected to the first one of the second inputs;
(b) measuring a voltage at each of the first inputs;
(c) measuring a voltage at each of the second inputs;
(d) determining a current through each one of the plurality of resistors by subtracting the measured voltage at a corresponding one of the first inputs from the supply voltage and dividing by the known resistance value of the respective one of the plurality of resistors;
(e) repeating (a) through (d) for each subsequent one of the second inputs;
(f) determining a resistance value for each RTS whose first end is connected to the respective first node connected to the first one of the first inputs by solving a matrix equation comprising (i) the measured voltages at each of the second inputs for each different one of the second inputs being set to ground, (ii) an unknown conductance value of each RTS whose first end is connected to the respective first node connected to the first one of the first inputs, and (iii) the determined current through the corresponding one of the plurality of resistors; and
repeating (f) for each subsequent one of the first inputs and groups of RTSs.

7. The method of claim 1, further comprising:
(a) setting a first one of the second inputs to ground and others of the second inputs to a high resistance mode such that current flows through each RTS connected to a corresponding one of the second nodes connected to the first one of the second inputs;
(b) measuring a plurality of differential voltages between each of the first inputs and the first one of the second inputs;
(c) measuring a plurality of differential voltages between the supply voltage and each of the first inputs;
(d) repeating (a) through (c) for each subsequent ones of the second inputs;
(d) determining a current through each one of the plurality of resistors by dividing the differential voltage between the supply voltage and a corresponding one of the first input by the known resistance value of the respective one of the plurality of resistors;
(e) repeating (a) through (d) for each subsequent ones of the second inputs; and
(f) determining a resistance value for each RTS whose first end is connected to the respective first node connected to the first one of the first inputs by solving a matrix equation comprising (i) the measured voltages at each of the second inputs for each different one of the second inputs being set to ground, (ii) an unknown conductance value of each RTS whose first end is connected to the respective first node connected to the first one of the first inputs, and (iii) the determined current through the corresponding one of the plurality of resistors.

8. A temperature sensing device comprising:
a plurality of first inputs and a plurality of second inputs; and
control circuitry;
wherein the control circuitry is adapted to determine a resistance of each of a plurality of resistive temperature sensors (RTSs) arranged in a plurality of groups, each group comprising a same number of RTSs, each RTS having a first end and a second end;
wherein, for each group of RTSs, the first end of each RTS in a same group is connected to a respective one of a plurality of first nodes;
wherein a first end of each of a plurality of resistors each having a known resistance value is connected to a supply voltage and a second end of each of the plurality of resistors to the first node of a respective group of RTSs;
wherein the second end of each RTS is connected to the second end of one respective RTS in each other group of RTSs via a respective one of a plurality of second nodes;
wherein each of the first nodes is connected to a respective first input of a device having a plurality of first inputs and a plurality of second inputs;
wherein each of the second nodes is connected to a respective second input of the device;
wherein a quantity of the resistors equals a quantity of the groups of the RTSs;
wherein a quantity of the first nodes equals a quantity of the groups of the RTSs; and
wherein a quantity of the second nodes equal a quantity of the RTSs in each group of the RTSs.

9. The device of claim 8, wherein the control circuitry is configured to:
(a) set a first one of the second inputs to ground and others of the second inputs to a high resistance mode such that current flows through each RTS connected to a corresponding one of the second nodes connected to the first one of the second inputs;
(b) measure a voltage at a first one of the first inputs;
(c) measure a voltage at each of the second inputs;
(d) determine a current through a corresponding one of the plurality of resistors by subtracting the measured voltage at the first one of the first inputs from the supply voltage and dividing by the known resistance value of the corresponding one of the plurality of resistors;
(e) repeat (a) through (d) for each subsequent ones of the second inputs; and
(f) determine a resistance value for each RTS whose first end is connected to the respective first node connected to the first one of the first inputs by solving a matrix equation comprising (i) the measured voltages at each of the second inputs for each different one of the second inputs being set to ground, (ii) an unknown conductance value of each RTS whose first end is connected to the respective first node connected to the first one of the first inputs, and (iii) the determined current through the corresponding one of the plurality of resistors.

10. The device of claim 9, wherein the control circuitry is further configured to repeat (a) through (f) for each subsequent one of the first inputs and groups of RTSs.

11. The device of claim 8, wherein each of the first inputs of the device comprises an analog-to-digital controller (ADC) and each of the second inputs of the device comprises a general purpose input.

12. The device of claim 8, wherein each of the RTSs comprise either a negative-temperature-coefficient sensor or a positive-temperature-coefficient sensor.

13. The device of claim 8, wherein the control circuitry is further configured to:
(a) set a first one of the second inputs to ground and others of the second inputs to a high resistance mode such that current flows through each RTS connected to a corresponding one of the second nodes connected to the first one of the second inputs;
(b) measure a voltage at each of the first inputs;
(c) measure a voltage at each of the second inputs;
(d) determine a current through each corresponding one of the plurality of resistors by subtracting the measured voltage at a corresponding one of the first inputs from the supply voltage and dividing by the known resistance value of the respective one of the plurality of resistors;
(e) repeat (a) through (d) for each subsequent ones of the second inputs; and
(f) determine a resistance value for each RTS whose first end is connected to the respective first node connected to the first one of the first inputs by solving a matrix equation comprising (i) the measured voltages at each of the second inputs for each different one of the second inputs being set to ground, (ii) an unknown conductance value of each RTS whose first end is connected to the respective first node connected to the first one of the first inputs, and (iii) the determined current through the corresponding one of the plurality of resistors; and
repeat (f) for each subsequent one of the first inputs and groups of RTSs.

14. The device of claim 8, wherein the control circuitry is further configured to:
(a) set a first one of the second inputs to ground and others of the second inputs to a high resistance mode such that current flows through each RTS connected to a corresponding one of the second nodes connected to the first one of the second inputs;
(b) measure a plurality of differential voltages between each of the first inputs and each of the second inputs;
(c) measure a plurality of differential voltages between the supply voltage and each of the first inputs;
(d) repeat (a) through (c) for each subsequent ones of the second inputs;
(d) determine a current through each one of the plurality of resistors by dividing the differential voltage between the supply voltage and a corresponding one of the first input by the known resistance value of the respective one of the plurality of resistors;
(e) repeat (a) through (d) for each subsequent ones of the second inputs; and
(f) determine a resistance value for each RTS whose first end is connected to the respective first node connected to the first one of the first inputs by solving a matrix equation comprising (i) the measured voltages at each of the second inputs for each different one of the second inputs being set to ground, (ii) an unknown conductance value of each RTS whose first end is connected to the respective first node connected to the first one of the first inputs, and (iii) the determined current through the corresponding one of the plurality of resistors.

15. A temperature sensing system, the system comprising:
a plurality of resistive temperature sensors (RTSs) arranged in a plurality of groups, each group comprising a same number of RTSs, each RTS adapted to be positioned adjacent a structure whose temperature is to be determined, wherein, for each group of RTSs, a first end of each RTS in a same group is connected to a respective one of a plurality of first nodes;
a plurality of resistors each having a fixed, known resistance value, a first end of each of the plurality of resistors is adapted to be connected to a supply voltage and a second end of each of the plurality of resistors is connected to the first node of a respective group of RTSs; and
a device having a plurality of first inputs and a plurality of second inputs;
wherein, for each group of RTSs, the first end of each RTS in a same group is connected to a respective one of a plurality of first nodes;
wherein a first end of each of a plurality of resistors each having a known resistance value is connected to a supply voltage and a second end of each of the plurality of resistors to the first node of a respective group of RTSs;
wherein the second end of each RTS is connected to the second end of one respective RTS in each other group of RTSs via a respective one of a plurality of second nodes;
wherein each of the first nodes is connected to a respective first input of a device having a plurality of first inputs and a plurality of second inputs;
wherein each of the second nodes is connected to a respective second input of the device;
wherein a quantity of the resistors equals a quantity of the groups of the RTSs;
wherein a quantity of the first nodes equals a quantity of the groups of the RTSs; and
wherein a quantity of the second nodes equal a quantity of the RTSs in each group of the RTSs.

16. The system of claim 15, wherein the device further comprises control circuitry configured to:
(a) set a first one of the second inputs to ground and others of the second inputs to a high resistance mode such that current flows through each RTS connected to a corresponding one of the second nodes connected to the first one of the second inputs;
(b) measure a voltage at a first one of the first inputs;
(c) measure a voltage at each of the second inputs;
(d) determine a current through a corresponding one of the plurality of resistors by subtracting the measured voltage at the first one of the first inputs from the supply voltage and dividing by the known resistance value of the corresponding one of the plurality of resistors;
(e) repeat (a) through (d) for each subsequent ones of the second inputs; and
(f) determine a resistance value for each RTS whose first end is connected to the respective first node connected to the first one of the first inputs by solving a matrix equation comprising (i) the measured voltages at each of the second inputs for each different one of the second inputs being set to ground, (ii) an unknown conductance value of each RTS whose first end is connected to the respective first node connected to the first one of the first inputs, and (iii) the determined current through the corresponding one of the plurality of resistors.

17. The system of claim 16, wherein the control circuitry is further configured to repeat (a) through (f) for each subsequent one of the first inputs and groups of RTSs.

18. The system of claim 15, wherein each of the first inputs of the device comprises an analog-to-digital controller (ADC) and each of the second inputs of the device comprises a general purpose input.

19. The system of claim 16, wherein the control circuitry is further configured to:
(a) set a first one of the second inputs to ground and others of the second inputs to a high resistance mode such that current flows through each RTS connected to a corresponding one of the second nodes connected to the first one of the second inputs;
(b) measure a voltage at each of the first inputs;
(c) measure a voltage at each of the second inputs;
(d) determine a current through each corresponding one of the plurality of resistors by subtracting the measured voltage at a corresponding one of the first inputs from the supply voltage and dividing by the known resistance value of the respective one of the plurality of resistors;
(e) repeat (a) through (d) for each subsequent ones of the second inputs; and
(f) determine a resistance value for each RTS whose first end is connected to the respective first node connected to the first one of the first inputs by solving a matrix equation comprising (i) the measured voltages at each of the second inputs for each different one of the second inputs being set to ground, (ii) an unknown conductance value of each RTS whose first end is connected to the respective first node connected to the first one of the first inputs, and (iii) the determined current through the corresponding one of the plurality of resistors; and
repeat (f) for each subsequent one of the first inputs and groups of RTSs.

20. The system of claim 16, wherein the control circuitry is further configured to:
(a) set a first one of the second inputs to ground and others of the second inputs to a high resistance mode such that current flows through each RTS connected to a corresponding one of the second nodes connected to the first one of the second inputs;
(b) measure a plurality of differential voltages between each of the first inputs and each of the second inputs;
(c) measure a plurality of differential voltages between the supply voltage and each of the first inputs;
(d) repeat (a) through (c) for each subsequent ones of the second inputs;
(d) determine a current through each one of the plurality of resistors by dividing the differential voltage between the supply voltage and a corresponding one of the first input by the known resistance value of the respective one of the plurality of resistors;
(e) repeat (a) through (d) for each subsequent ones of the second inputs; and
(f) determine a resistance value for each RTS whose first end is connected to the respective first node connected to the first one of the first inputs by solving a matrix equation comprising (i) the measured voltages at each of the second inputs for each different one of the second inputs being set to ground, (ii) an unknown conductance value of each RTS whose first end is connected to the respective first node connected to the first one of the first inputs, and (iii) the determined current through the corresponding one of the plurality of resistors.
